(19) United States
(12) Patent Application Publication
(10) Pub. No.: US 2020/0260107 A1
(43) Pub. Date: Aug. 13, 2020

(54) VIRTUAL PIPELINE DATA UNIT DESIGN FOR INTRA BLOCK COPY MODE FOR VIDEO CODING

(71) Applicant: QUALCOMM Incorporated, San Diego, CA (US)

(72) Inventors: Yu Han, San Diego, CA (US); Wei-Jung Chien, San Diego, CA (US); Hongtao Wang, San Diego, CA (US); Han Huang, San Diego, CA (US); Marta Karczewicz, San Diego, CA (US)

(21) Appl. No.: 16/789,197

(22) Filed: Feb. 12, 2020

Related U.S. Application Data
(60) Provisional application No. 62/805,198, filed on Feb. 13, 2019.

(51) Int. Cl. H04N 19/52; H04N 19/159; H04N 19/176; H04N 19/96; H04N 19/563

(52) U.S. Cl. CPC H04N 19/52; H04N 19/159; H04N 19/563; H04N 19/96; H04N 19/176

(57) ABSTRACT

An example device for coding video data includes a memory configured to store video data; and one or more processors implemented in circuitry and configured to: determine that a current block of a current picture of video data is to be predicted using intra-block copy (IBC) mode; determine up to N reference units that are available for use as reference to predict the current block using IBC mode, N being an integer value less than a total number of previously coded reference units of the current picture; generate a prediction block for the current block using one or more of the N reference units according to IBC mode; and code the current block using the prediction block. The current block may be a current coding unit (CU), and the reference units may be previously coded coding tree units (CTUs) in a row of CTUs including the current CU.

This application claims the benefit of U.S. Provisional Application No. 62/805,198, filed Feb. 13, 2019, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to intra block copy (IBC) mode and shared motion vector predictor list design. These techniques may be applied to any of the existing video codecs, such as HEVC (High Efficiency Video Coding), VVC (Versatile Video Coding), or may be an efficient coding tool in future video coding standards. In particular, this disclosure describes techniques for determining reference units (e.g., blocks of previously coded video data) to be stored in memory for use as reference when performing IBC mode. By storing only certain blocks in memory, other blocks can be removed from the memory, thereby reducing memory consumption. Reduced memory consumption may improve video coder performance in that smaller amounts of data can be used to identify reference data (e.g., smaller amounts of data to code motion vectors) and physical memory units can be smaller thereby reducing processing operations, battery consumption, and heat generation.

In one example, a method of coding video data includes determining that a current block of a current picture of video data is to be predicted using intra-block copy (IBC) mode; determining up to N reference units that are available for use as reference to predict the current block using IBC mode, N being an integer value less than a total number of previously coded reference units of the current picture; generating a prediction block for the current block using one or more of the N reference units according to IBC mode; and coding the current block using the prediction block.

In another example, a device for coding video data includes a memory configured to store video data; and one or more processors implemented in circuitry and configured to: determine that a current block of a current picture of video data is to be predicted using intra-block copy (IBC) mode; determine up to N reference units that are available for use as reference to predict the current block using IBC mode, N being an integer value less than a total number of previously coded reference units of the current picture; generate a prediction block for the current block using one or more of the N reference units according to IBC mode; and code the current block using the prediction block.

In another example, a device for coding video data, the device comprising: means for determining that a current block of video data is to be predicted using intra-block copy (IBC) mode; means for determining up to N reference units that are available for use as reference to predict the current block using IBC mode, N being an integer value less than a total number of previously coded reference units of the current picture; means for generating a prediction block for the current block using one or more of the N reference units according to IBC mode; and means for coding the current block using the prediction block.

In another example, a computer-readable storage medium has stored thereon instructions that, when executed, cause a processor to: determine that a current block of a current picture of video data is to be predicted using intra-block copy (IBC) mode; determine up to N reference units that are available for use as reference to predict the current block using IBC mode, N being an integer value less than a total number of previously coded reference units of the current picture; generate a prediction block for the current block using one or more of the N reference units according to IBC mode; and code the current block using the prediction block.

The details of one or more examples are set forth in the accompanying drawings and the description below. Other features, objects, and advantages will be apparent from the description, drawings, and claims.

### BRIEF DESCRIPTION OF DRAWINGS

FIGS. 1A and 1B are conceptual diagrams illustrating spatial neighboring motion vector candidates for merge mode and advanced motion vector prediction (AMVP) mode, respectively.

FIGS. 2A and 2B are conceptual diagrams illustrating an example of temporal motion vector prediction (TMVP)

FIG. 3 is a conceptual diagram illustrating wavefront parallel processing of rows of coding tree units (CTUs).

FIG. 4 is a block diagram illustrating an example video encoding and decoding system that may perform the techniques of this disclosure.

FIGS. 5A and 5B are conceptual diagrams illustrating an example quadtree binary tree (QTBT) structure, and a corresponding coding tree unit (CTU).

FIG. 6 is a conceptual diagram illustrating an example of latest coded CTUs that can be used as reference for coding a current CTU, e.g., for intra block copy (IBC) mode.

FIG. 7 is a conceptual diagram illustrating another example of latest coded CTUs in the same row as a current CTU that can be used as reference for coding the current CTU, e.g., for IBC mode.

FIG. 8 is a conceptual diagram illustrating another example of closest coded CTUs that can be used as reference for coding a current CTU, e.g., for IBC mode.

FIG. 9 is a block diagram illustrating an example video encoder that may perform the techniques of this disclosure.

FIG. 10 is a block diagram illustrating an example video decoder that may perform the techniques of this disclosure.

FIG. 11 is a flowchart illustrating an example method for encoding a current block in accordance with the techniques of this disclosure.

FIG. 12 is a flowchart illustrating an example method for decoding a current block in accordance with the techniques of this disclosure.

FIG. 13 is a flowchart illustrating an example method of coding video data according to the techniques of this disclosure.

### DETAILED DESCRIPTION

In general, this disclosure is directed to techniques for improving memory utilization related to performing intra-block copy (IBC) mode prediction for video coding. Video data is represented by a series of pictures. Each picture may be partitioned into blocks, and a video coder (encoder or decoder) may code each block. Coding a block generally includes forming a prediction block using a prediction mode, and coding a residual representing sample-by-sample differences between the prediction block and the actual block. Video encoding generally includes encoding data for the prediction mode and the residual, while video decoding generally includes decoding the residual and the data for the prediction mode, and reconstructing blocks by combining samples of residual blocks with corresponding samples of prediction blocks.

Prediction modes can be performed inter-picture (referred to as “inter-prediction” modes) or intra-picture (referred to as “intra-prediction” modes). In order to form a prediction block, a video coder retrieves data from a reference block of previously coded data, which is stored in memory. Intra-prediction modes include spatial prediction modes, in which a video coder forms a prediction block for a current block using data of previously coded blocks spatially neighboring the current block. Intra-prediction modes also include IBC mode, in which the video coder forms the prediction block using a previously coded block of a current picture including the current block, identified by a motion vector (also referred to as a block vector).

Generally, for intra-prediction modes, blocks near a current block will be more likely to contain reference data that will be similar to the current block. The techniques of this disclosure are generally directed to reducing the amount of memory consumed by reference data of a current picture to be used for IBC mode. In particular, this disclosure describes various techniques for determining which data is to be stored in the memory for use as reference data, and which data can be discarded from memory. Thus, by applying these techniques, reference data stored in the memory can be reduced. Accordingly, a total size of the memory in a video coder can be reduced, which may reduce power consumption and heat generation, as well as allowing the physical memory unit to be physically smaller, thereby allowing a device and/or card or chip including the memory unit to be physically smaller. Furthermore, by reducing the amount of data stored as reference data, values used to identify the reference data can be smaller, and thus, the size of the bitstream can be reduced. These and other advantages may be achieved through the application of these techniques, which may be performed alone or in various combinations.

According to various techniques of this disclosure, a video coder may determine a number (e.g., N) of reference units to be available for use as reference to predict a current block using IBC mode. The reference units may be blocks, coding tree units (CTUs), groups of pixel samples, or other such units. The number N may be an integer value that is less than a total number of previously coded units of the current picture. For example, the number of reference units may be up to N most recently coded units (e.g., blocks) preceding the current block in coding order. As another example, the number of reference units may be up to N most recently coded reference units preceding the current block in coding order and also being within a row including the current block but excluding reference units outside of the row including the current block. As yet another example, the reference units may be up to N reference units having a closest distance to the current block. In another example, the reference units may be up to N reference units within a slice including the current block and may exclude reference units outside of the slice. In another example, the reference units may be up to N reference units within a tile including the current block and may exclude reference units outside of the tile. In another example, the reference units may be up to N available reference units and exclude reference units that are not available.

The video coder may determine the number of reference units in various ways. For example, the video coder may determine the number of reference units according to a size of a virtual pipeline data unit (VPDU). A VPDUs are generally non-overlapping units of samples in a picture. The size of these units may vary for luminance and chrominance data. In one example, luminance VPDUs are 64×64 samples and chrominance VPDUs are 32×32 samples. VPDUs may be larger or smaller than coding units (CUs), and thus, a VPDU may contain a CU, and/or a CU may contain a VPDU. When a VPDU includes a CU, the CU may be fully contained within the VPDU. When a CU contains a VPDU, the VPDU may be fully contained within the CU. In general, video coders may be configured to fully code data within a VPDU before beginning coding of another VPDU. That is, a video coder may avoid revisiting coding of data within a VPDU after having stopped coding data within the VPDU. Using VPDUs in this way may reduce the amount of data stored in memory of a video coder.

Additionally or alternatively, the video coder may determine the number of reference units according to a size of a CTU. In some examples, the number of reference units is a fixed value, selected from a set of fixed values, or signaled in a bitstream as a value of a syntax element. The syntax element may be included within a parameter set, such as a video parameter set (VPS), sequence parameter set (SPS), picture parameter set (PPS), or other structure, such as a slice header, a coding tree unit header, or coding unit header.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, High Efficiency Video Coding (HEVC) or ITU-T H.265, including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). An HEVC specification, referred to hereinafter as “HEVC WD,” is available from phenix.int-evry.fr/jct/doc_end_user/documents/14_Vienna/wg11/JCTVC-N1003-v1.zip.

In HEVC, the largest coding unit in a slice is called a coding tree block (CTB) or coding tree unit (CTU). A CTB contains a quad-tree the nodes of which are coding units. The size of a CTB can range from 16×16 to 64×64 in the HEVC main profile (although technically 8×8 CTB sizes can be supported). A coding unit (CU) could be the same size of a CTB to as small as 8×8. Each coding unit is coded with one mode, i.e. inter or intra. When a CU is inter coded, it may be further partitioned into 2 or 4 prediction units (PUs) or become just one PU when further partition doesn't apply. When two PUs are present in one CU, they can be half size rectangles or two rectangle size with ¼ or ¾ size of the CU. When the CU is inter coded, each PU has one set of motion information, which is derived with a unique inter prediction mode.

In HEVC, there are two inter prediction modes, named merge (skip is considered as a special case of merge) and advanced motion vector prediction (AMVP) modes respectively for a prediction unit (PU). In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures used for the prediction of the current blocks, as well as the associated motion vectors are determined. On the other hand, under AMVP mode for each potential prediction direction from either list 0 or list 1, a reference index needs to be explicitly signaled, together with an MV predictor (MVP) index to the MV candidate list since the AMVP candidate contains only a motion vector. In AMVP mode, the predicted motion vectors can be further refined. The candidates for both modes are derived similarly from the same spatial and temporal neighboring blocks.

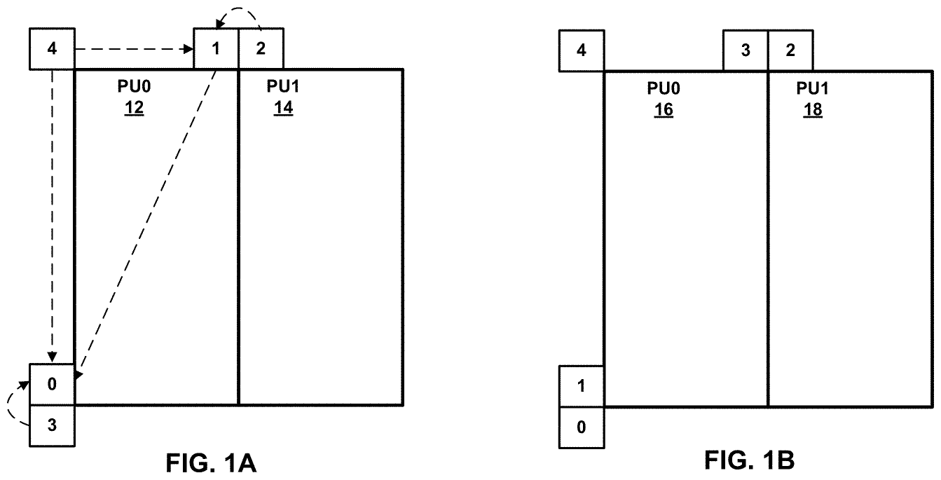

FIGS. 1A and 1B are conceptual diagrams illustrating spatial neighboring motion vector candidates for merge mode and AMVP mode, respectively. In particular, FIG. 1A illustrates motion vector candidates 0, 1, 2, 3, and 4 for PU 12 for merge mode, while FIG. 1B illustrates motion vector candidates 0, 1, 2, 3, and 4 for PU 16 for AMVP mode. In FIG. 1A, a coding unit (CU) is partitioned into PU 12 and PU 14, while in FIG. 1B, a CU is partitioned into PU 16 and PU 18. In HEVC, spatial MV candidates are derived from the neighboring blocks shown in FIGS. 1A and 1B, for a specific PU (PUo), although the methods for generating the candidates from the blocks differ for merge and AMVP modes.

In merge mode, up to four spatial MV candidates can be derived with the orders shown in FIG. 1A with numbers, and the order is the following: left (0, A1), above (1, B1), above right (2, B0), below left (3, A0), and above left (4, B2).

In AVMP mode according to HEVC, the neighboring blocks are divided into two groups: left group consisting of the block 0 and 1, and above group consisting of the blocks 2, 3, and 4, as shown in FIG. 1B. For each group, the potential candidate in a neighboring block referring to the same reference picture as that indicated by the signaled reference index has the highest priority to be chosen to form a final candidate of the group. It is possible that all neighboring blocks don't contain a motion vector pointing to the same reference picture. Therefore, if such a candidate cannot be found, the first available candidate will be scaled to form the final candidate, thus the temporal distance differences can be compensated.

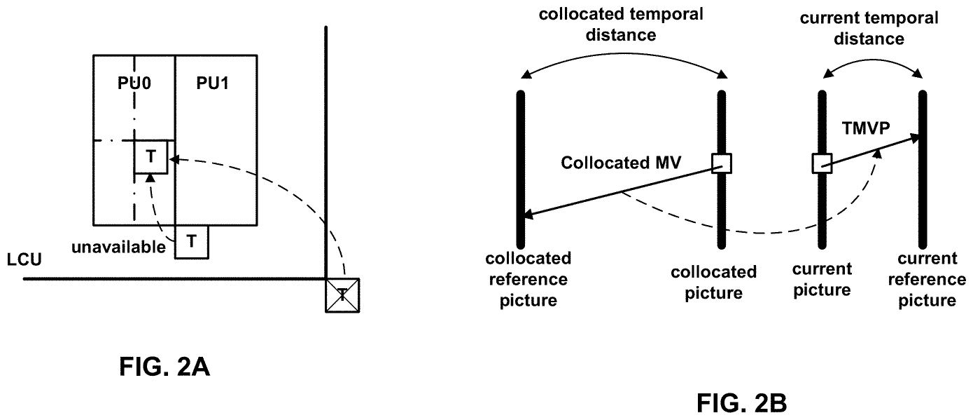

FIGS. 2A and 2B are conceptual diagrams illustrating an example of temporal motion vector prediction (TMVP). If enabled and available, a video coder according to HEVC adds a TMVP candidate into the MV candidate list after spatial motion vector candidates. The process of motion vector derivation for TMVP candidate is the same for both merge and AMVP modes. However, the target reference index for the TMVP candidate in the merge mode is always set to 0.

The primary block location for TMVP candidate derivation per HEVC is the bottom right block outside of the collocated PU, as shown in FIG. 2A as block “T,” to compensate the bias to the above and left blocks used to generate spatial neighboring candidates. However, if the bottom right block is located outside of the current CTB row or motion information is not available for the bottom right block, the TMVP candidate is substituted with a center block of the PU.

According to HEVC, a motion vector for the TMVP candidate is derived from the co-located PU of the co-located picture, indicated in the slice level. The motion vector for the co-located PU is called the collocated MV. Similar to temporal direct mode in AVC, to derive the TMVP candidate motion vector, the co-located MV needs to be scaled to compensate the temporal distance differences, as shown in FIG. 2B.

HEVC includes a motion vector scaling process. It is assumed that the value of motion vectors is proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values. For a motion vector to be predicted, both its associated containing picture and reference picture may be different. Therefore, a new distance (based on POC) is calculated. And the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

HEVC includes a process for generating artificial motion vector candidates. If a motion vector candidate list is not complete, artificial motion vector candidates are generated and inserted at the end of the list until it will have all candidates. In merge mode, there are two types of artificial MV candidates: combined candidate derived only for B-slices and zero candidates used only for AMVP if the first type doesn't provide enough artificial candidates. For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

HEVC also includes a pruning process for candidate insertion. Candidates from different blocks may happen to be the same, which decreases the efficiency of a merge/AMVP candidate list. A pruning process is applied to solve this problem. It compares one candidate against the others in the current candidate list to avoid inserting identical candidate in certain extent. To reduce the complexity, only limited numbers of pruning process is applied instead of comparing each potential one with all the other existing ones.

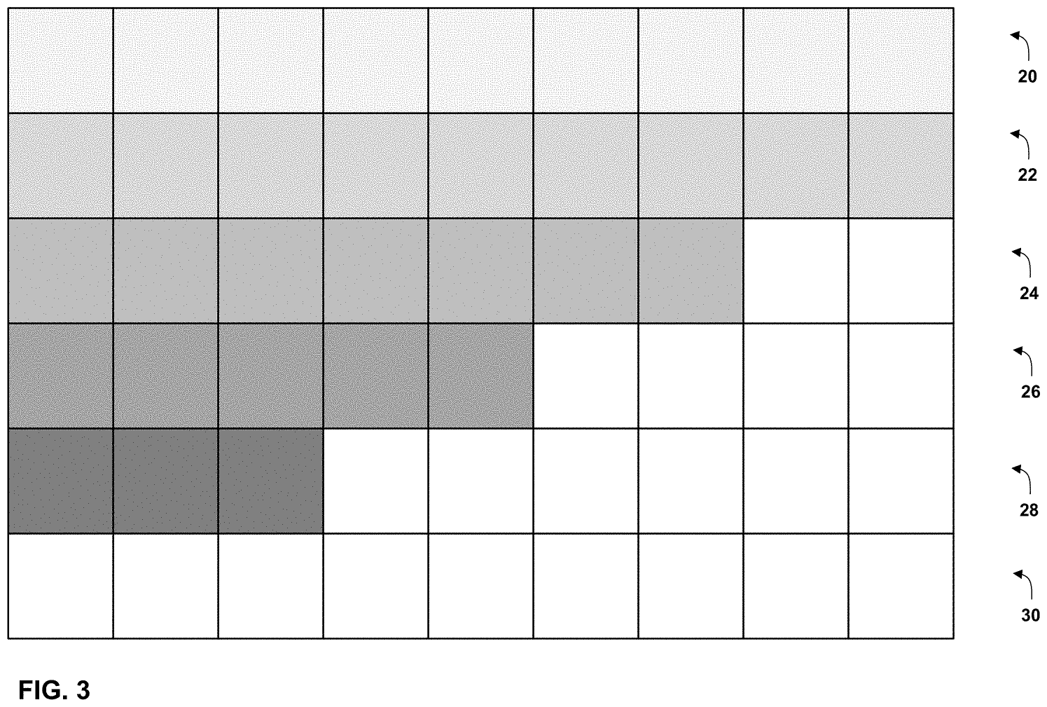

FIG. 3 is a conceptual diagram illustrating wavefront parallel processing of rows of CTUs. In HEVC, wavefront parallel processing (WPP) allows each row of CTUs to be coded in parallel, so long as each row stays at least two CTUs behind the row above it, to ensure the intra references and other data of the blocks above and above-right are available. FIG. 3 depicts various rows 20, 22, 24, 26, 28, 30 of CTUs that can be processed in parallel. The CTUs of a given row that can be processed in parallel with the other rows are shaded in various shades of grey. As shown in FIG. 3, row 24 includes two fewer CTUs being coded in parallel compared to rows 20 and 22; row 26 includes two fewer CTUs being coded in parallel compared to row 24; and row 28 includes two fewer CTUs being coded in parallel compared to row 26.

ITU-T VCEG (Q6/16) and ISO/IEC MPEG (JTC 1/SC 29/WG 11) are studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. A version of reference software, i.e., Joint Exploration Model 7 (JEM 7), is available at jvet.hhi.fraunhofer.de/svn/svn_HMJEMSoftware/tags/HM-16.6-JEM-7.0/. An algorithm description of Joint Exploration Test Model 7 (JEM7) is provided in “Algorithm Description of Joint Exploration Test Model 7 (JEM 7),” JVET of ITU-T SG 16 WP 3 and ISO/IEC JTC 1/SC 29/WG 11, 7th Meeting: Torino, IT, 13-21 Jul. 2017, document JVET-G1001-v1, available at phenix.it-sudparis.eu/jvet/doc_end_user/current_document.php?id=3286.

Development of Versatile Video Coding (VVC) includes development of several inter coding tools which derive or refine the candidate list of motion vector prediction or merge prediction for a current block. History-based motion vector prediction (HMVP), as described in Zhang et al., “CE4-related: History-based Motion Vector Prediction”, JVET of ITU-T SG 16 WP 3 and ISO/IEC JTC 1/SC 29/WG 11, Jul. 18, 2018, document JVET-K0104-v5, available at phenix.it-sudparis.eu/jvet/doc end user/current document.php?id=3607, is a history-based method that allows each block to find its MV predictor from a list of MVs decoded from the past in additional to those in immediately adjacent causal neighboring motion fields. A table with multiple HMVP candidates is maintained during the encoding/decoding process. The table is emptied when a new slice is encountered. Whenever there is an inter-coded block, the associated motion information is inserted to the table in a first-in-first-out (FIFO) fashion as a new HMVP candidate. Then, a constraint FIFO rule can be applied. When inserting a HMVP to the table, redundancy check is firstly applied to find whether there is an identical HMVP in the table. If found, that particular HMVP is removed from the table and all the HMVP candidates afterwards are moved.

HMVP candidates could be used in the merge candidate list construction process. All HMVP candidates from the last entry to the first entry in the table may be inserted after the TMVP candidate. Pruning may be applied on the HMVP candidates. Once the total number of available merge candidates reaches the signaled maximally allowed merge candidates, the merge candidate list construction process may be terminated.

Similarly, HMVP candidates could also be used in the AMVP candidate list construction process. The motion vectors of the last K HMVP candidates in the table are inserted after the TMVP candidate. Only HMVP candidates with the same reference picture as the AMVP target reference picture are used to construct the AMVP candidate list. Pruning may be applied on the HMVP candidates.

Pairwise average candidates are used in the VVC test model 3.0 (VTM3.0). Pairwise average candidates per VTM3.0 are generated by averaging predefined pairs of candidates in the current merge candidate list (includes spatial candidates, TMVP, and HMVP), and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. The pairwise average candidates replace the combined candidates in HEVC standard, per VTM3.0.

In VTM4.0, for normal inter merge mode the size of merge list is 6, the order of merge candidate list is as below:

1. Spatial candidates for blocks A1, B1, B0 and A0.

2. If number of candidates less than 4, add B2.

3. TMVP candidate.

4. HMVP candidates (can't be the last candidate in the list).

5. Pairwise candidates.

6. Zero candidates.

In VTM4.0, for IBC mode, the size of merge list is 6, the order of merge candidate list is as below:

1. Spatial candidates for blocks A1, B1, B0 and A0.

2. If number of candidates less than 4, add B2.

3. HMVP candidates (can't be the last candidate in the list).

4. Pairwise candidates.

For IBC mode, if the candidates are valid, the video coder may add them into a merge/skip list, per the VTM. “Valid candidate” means the candidate should be coded in IBC mode. A video coder may further prune candidates as follows: the video coder prunes B1 based on A1. If B1 is different from A1, the video coder adds B1 into the merge/skip list. The video coder may also prune B0 by B1, and A0 by A1. If the number of candidates is less than 4, the video coder may check B2 and prune B2 using A1 and B1. The video coder may prune the first 2 HMVP candidates by A1 and B1; pairwise candidates don't need to be pruned.

Intra block copy (IBC) is sometimes referred to as current picture referencing (CPR), where a motion vector refers to the previously reconstructed reference samples in the current picture. IBC was supported in HEVC screen content coding extension (HEVC SCC). An IBC-coded CU may be signaled as an inter coded block. The luma motion (or block) vector of an IBC-coded CU may be in integer precision. The chroma motion vector may be clipped to integer precision as well. When combined with advanced motion vector resolution (AMVR), the IBC mode can switch between 1-pel and 4-pel motion vector precisions. The current picture is placed at the end of the reference picture list L0. To reduce memory consumption and decoder complexity, the IBC in VTM-3.0 allows only the reconstructed portion of the current CTU to be used. This restriction allows the IBC mode to be implemented using local on-chip memory for hardware implementations.

At the encoder side, hash-based motion estimation may be performed for IBC. The encoder may perform a rate-distortion (RD) check for blocks with either width or height no larger than 16 luma samples. For non-merge mode, the block vector search may be performed using hash-based search first. If a hash search does not return valid candidate, a video coder may perform block matching based on a local search.

In VTM4.0, IBC mode is signaled with a block level flag and can be signaled as IBC AMVP mode or IBC skip/merge mode. IBC mode is treated as the third prediction mode other than intra or inter prediction modes. The current picture is no longer included as one of the reference pictures in the reference picture list 0. The derivation process of motion vectors for IBC mode excludes all neighboring blocks in inter mode and vice versa. Bitstream conformance checks are no longer needed at the encoder and redundant mode signaling is removed.

The concept of the virtual pipeline data unit (VPDU) was adopted in the 12^{th} JVET meeting. VPDUs are defined as non-overlapping units of 64×64 luminance/32×32 chrominance samples in the picture. The following constraint has been proposed:
Condition 1: For each VPDU containing one or multiple CUs, the CUs are completely contained in the VPDU.
Condition 2: For each CU containing one or more VPDUs, the VPDUs are completely contained in the CU.
Proposed constraint: For each CTU, the above two conditions shall not be violated, and the processing order of CUs shall not leave a VPDU and re-visit it later.

The goal of VPDU is to guarantee completion of the processing of one 64×64 square region before starting the processing of other 64×64 square regions. This method is intended to reduce the memory footprint of pipelined hardware implementations.

IBC mode as an independent mode was adopted in the 13^{th} JVET meeting. VPDUs can be used to store reference samples for IBC mode for reference. The searching window should be defined and optimized for IBC mode. How many samples need to be stored in the VPDU may be optimized.

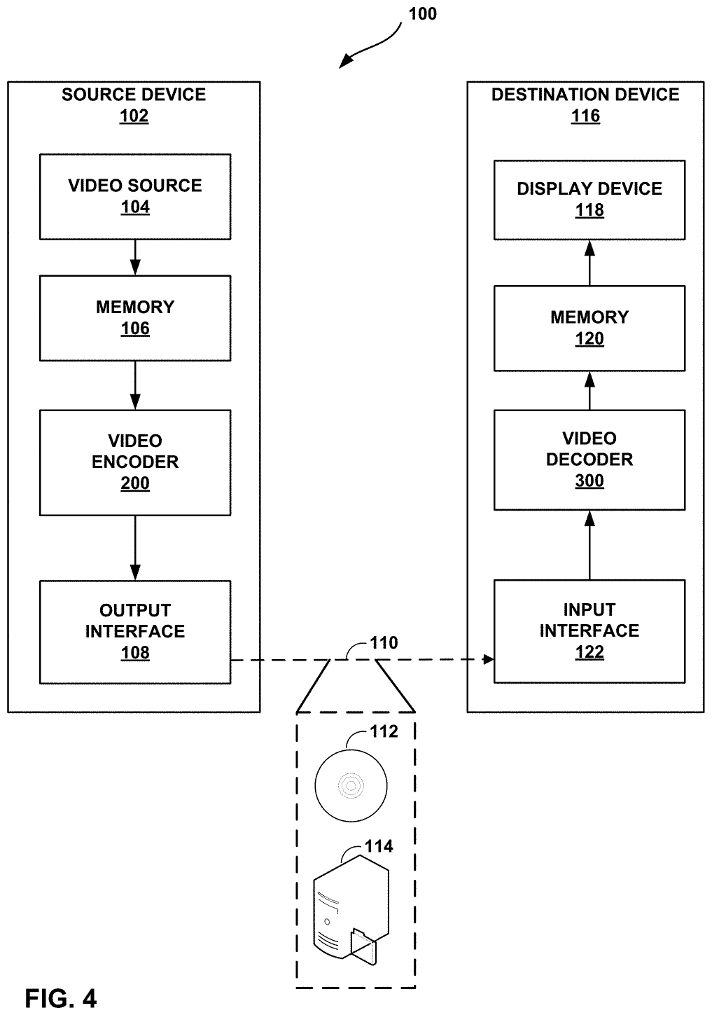

FIG. 4 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 4, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 4, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for coding virtual data pipeline units (VPDUs) for intra block copy mode for video coding. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 4 is merely one example. In general, any digital video encoding and/or decoding device may perform techniques for coding VPDUs for intra block copy mode for video coding. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 116. Similarly, destination device 116 may access encoded data from storage device 116 via input interface 122. Storage device 116 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 4, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM) or ITU-T H.266, also referred to as Versatile Video Coding (VVC). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM or VVC. According to JEM or VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) partitions. A triple tree partition is a partition where a block is split into three sub-blocks. In some examples, a triple tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of JEM and VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of JEM and VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In accordance with the techniques of this disclosure, video encoder 200 and video decoder 300 may be configured to code VPDUs for intra block copy mode for video coding, as discussed in greater detail below.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

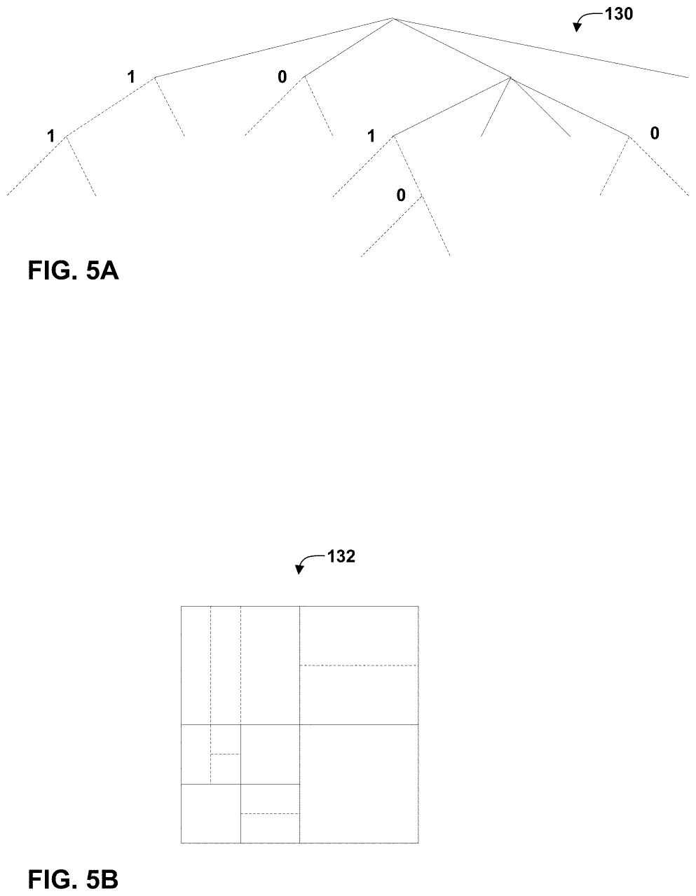

FIGS. 5A and 5B are conceptual diagram illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 5B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

In accordance with the techniques of this disclosure, video encoder 200 and video decoder 300 may be configured to code VPDUs for intra block copy mode for video coding. In one example, video encoder 200 and video decoder 300 may use a defined N reference units (that is, previously coded areas) as reference for the current area being coded (also referred to as the “current coding area”) in IBC mode. The reference units can be CTUs, blocks, or groups of pixel samples. The current area being coded can be CTU, block, or pixel samples. The definition of current area being coded can be the same as a reference unit, or not. In one example, both of the reference units and the current area being coded (i.e., the current coded area) are CTUs. In another example, the coded area is a group of pixel samples, while the current coding area is CTU. For example, a defined group of N samples can be used as reference for the current coding area.

According to the techniques of this disclosure, video encoder 200 and video decoder 300 may determine that a current block of a current picture of video data is to be predicted using intra-block copy (IBC) mode. For example, video encoder 200 may perform multiple encoding passes using various combinations of encoding decisions, such as partitionins, prediction modes, and the like. Video encoder 200 may calculate rate-distortion optimization (RDO) values for the various encoding passes and determine that for a particular block, the block is to be predicted using IBC mode. Video encoder 200 may encode data indicating that the block is to be predicted using IBC mode. Thus, video decoder 300 may decode data indicating that a block is to be predicted using IBC mode, and thereby determine that IBC mode is to be used for the block.

Video encoder 200 and video decoder 300 may also determine up to N reference units that are available for use as reference to predict the current block using IBC mode. N may be an integer value less than a total number of previously coded reference units of the current picture. In some examples, the N reference units may be the N most recently coded reference units. In some examples, the N reference units may be the N most recently coded reference units that are also in the same row as the current block being coded. In some examples, the N reference units may be the N previously coded reference units in the current picture that have the closest distance to the current block. In some examples, the N reference units may be the N most recently coded reference units in the same slice or tile as the current block. As noted above, the reference units may be CTUs, blocks (e.g., CUs), groups of pixels/samples, or the like.

In some examples, video encoder 200 and video decoder 300 may determine the value of N according to a size of a VPDU for the video data. In some examples, video encoder 200 and video decoder 300 may determine the value of N according to a size of a CTU for the video data. In some examples, video encoder 200 may determine the value of N using rate-distortion optimization (RDO), and signal the value of N as a syntax element, e.g., in a sequence parameter set (SPS), picture parameter set (PPS), video parameter set (VPS), picture header, slice header, CTU header, CU header, or the like.

Video encoder 200 and video decoder 300 may also generate a prediction block for the current block using one or more of the N reference units according to IBC mode. For example, video encoder 200 and video decoder 300 may use a motion vector (or block vector) to determine a reference block within the one or more N reference units and to form a prediction block. Video encoder 200 may perform a search to identify the reference block and encode the motion vector, e.g., using merge mode or AMVP, while video decoder 300 may decode the motion vector using data of the bitstream.

Video encoder 200 and video decoder 300 may also code (encode or decode, respectively) the current block using the prediction block. In particular, video encoder 200 may calculate sample-by-sample differences between the current block and the prediction block to generate a residual block, then encode the residual block, e.g., using a transformation, quantization, and entropy encoding process. Video decoder 300 may entropy decode quantized transform coefficients, then inverse quantize and inverse transform the quantized transform coefficients to reproduce the residual block. Video decoder 300 may further combine samples of the prediction block with samples of the residual block to reproduce (i.e., decode) the current block.

Accordingly, video encoder 200 and video decoder 300 may perform the various techniques of this disclosure. Moreover, by performing these techniques, video encoder 200 and video decoder 300 may achieve various possible advantages of the techniques of this disclosure. For example, a memory of video encoder 200 and video decoder 300 for storing reference units may be smaller than if all previously coded reference units of a current picture were stored in the memory. Likewise, a bitstream coded by video encoder 200 and video decoder 300 may be smaller than a bitstream coded using other techniques. Likewise, video encoder 200 and video decoder 300 may perform fewer processing operations than other video coding devices that do not perform these techniques when performing IBC.

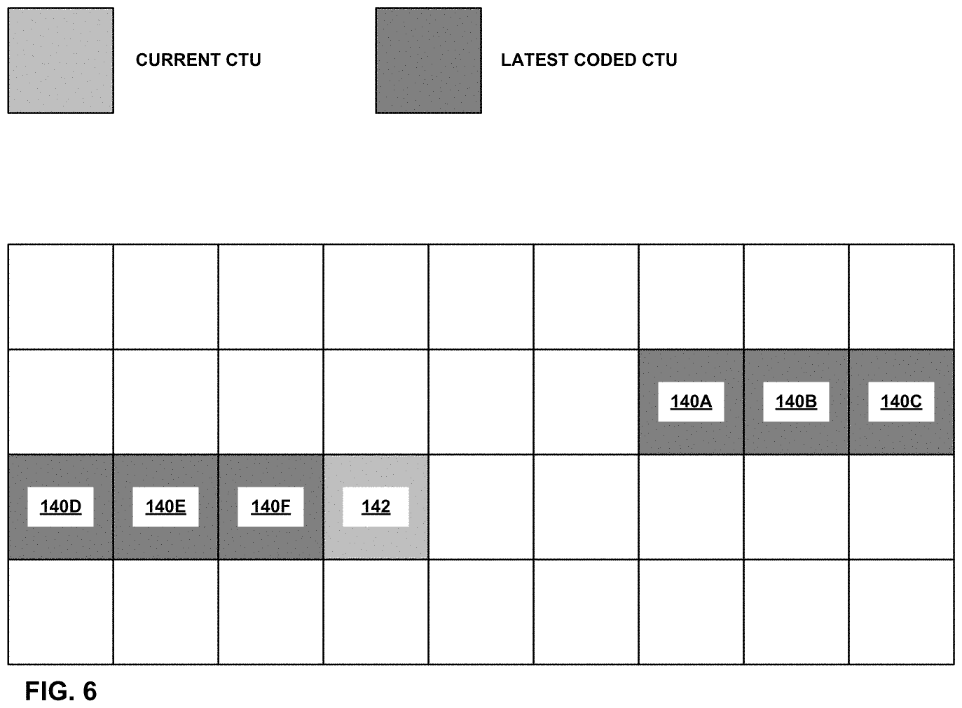

FIG. 6 is a conceptual diagram illustrating an example of latest coded CTUs that can be used as reference for coding a current CTU, e.g., for intra block copy (IBC) mode. In this example, both of reference units 140A-140F (reference units 140) and current coding area (current CTU 142) are CTUs, although in other examples, these areas may be blocks, groups of pixels/samples, or other units of video data. Video encoder 200 and video decoder 300 may use the N latest coded (i.e., most recently coded) CTUs (reference units 140) as reference for current CTU 142, e.g., as shown in FIG. 6. In this manner, FIG. 6 represents an example of N most recently coded reference units being up to N reference units that are available for a current block of video data.

In one example, video encoder 200 and video decoder 300 determine a value for N according to (e.g., as a function of) the size of the VPDU. For example, full use the size of VPDU, if the size of VPDU is 128×128 and the size of CTU is 32×32, the number of N is equal to 15=((128×128)/(32×32))−1. In another example, video encoder 200 and video decoder 300 may determine the value of N according to the size of the CTU. In another example, the value for N is fixed. For example, N may be 1, 2, 3, or other values.

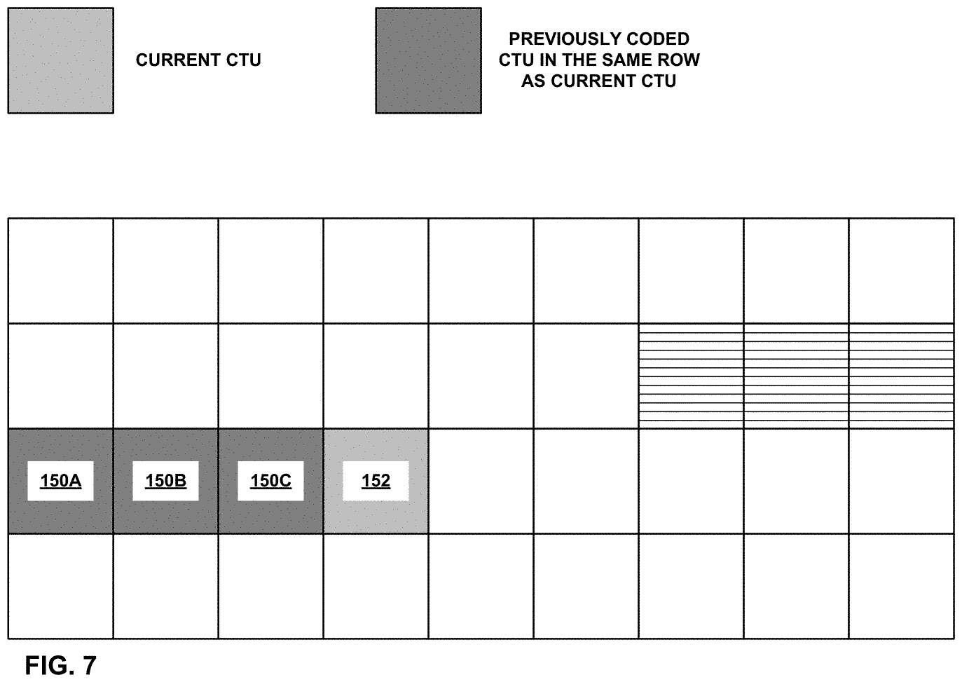

FIG. 7 is a conceptual diagram illustrating another example of latest coded CTUs in the same row as a current CTU that can be used as reference for coding the current CTU, e.g., for IBC mode. In particular, in this example, reference CTUs 150A-150C (reference CTUs 150) are within the same row as current CTU 152 and are the most recently coded reference CTUs. Although the example of FIG. 7 is directed to CTUs, it should be understood that in other examples, CUs, blocks, groups of pixels/samples, or other units may be used.

Video encoder 200 and video decoder 300 may use up to N previously coded units (such as CTUs, blocks/CUs, groups of samples, or the like) that are in the same line (or row) as current CTU 152, in this example, as reference units for coding current CTU 152 using IBC mode. The horizontally and vertically shaded blocks represent blocks of FIG. 7 within the N previous blocks, but are not in the same row as the CTU currently being coded, and therefore, are not used as reference for the CTU currently being coded, in this example.

In one example, video encoder 200 and video decoder 300 may determine the number N (that is, the number of previously coded units, e.g., CTUs, blocks, or the like) according to the size of the VPDU. For example, full use the size of VPDU, but the coded CTUs must be in the same line as the current coding CTU. In another example, video encoder 200 and video decoder 300 may determine the value of N according to the size of the CTU. In another example, the value for N is fixed. For example, N may be 1, 2, 3, or other values.

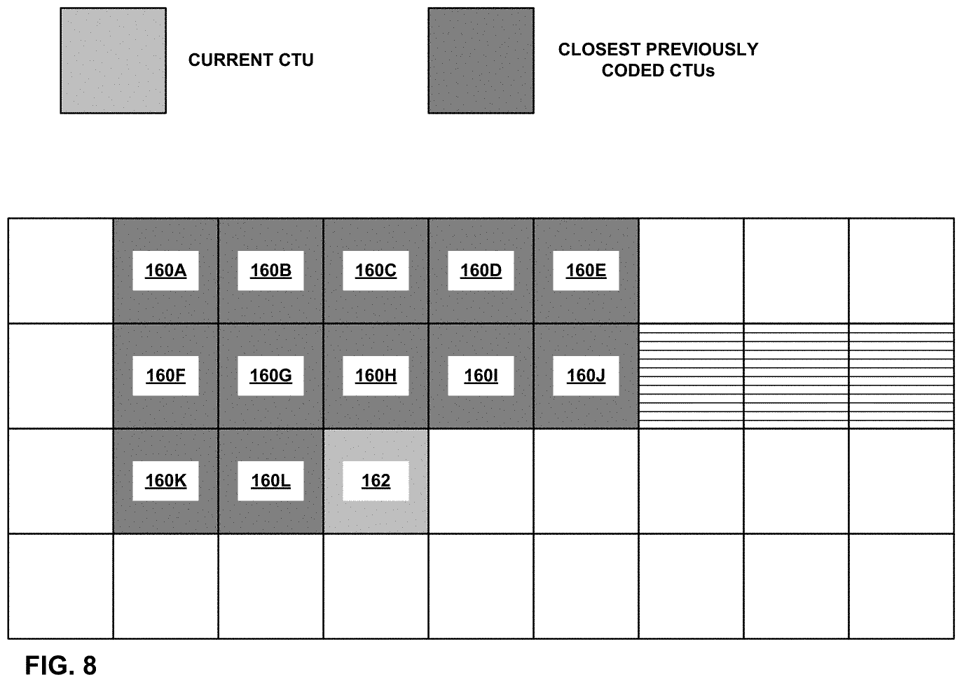

FIG. 8 is a conceptual diagram illustrating another example of closest coded CTUs that can be used as reference for coding a current CTU, e.g., for IBC mode. In this example, both of the reference units and the current coding area are CTUs, namely reference CTUs 160A-160L (reference CTUs 160) and current CTU 162. Video encoder 200 and video decoder 300 may use reference CTUs 160 that are closest in distance to current CTU 162 as reference when predicting current CTU 162 using IBC mode. The other blocks are not used for reference, in this example.

Video encoder 200 and video decoder 300 may calculate distance for determining the coded CTUs that are closest in distance to current CTU 162 according to the position of the current CTU 162. For example, video encoder 200 and video decoder 300 may determine reference CTUs 160 as including previously coded CTUs that are within two CTUs of current CTU 162, per FIG. 8.

In one example, video encoder 200 and video decoder 300 may determine the number of N according to the size of the VPDU. For example, full use the size of VPDU, but the coded CTUs must be in the same line as the current coding CTU. In another example, video encoder 200 and video decoder 300 may determine the value of N according to the size of the CTU. In another example, the value for N is fixed. For example, N may be 1, 2, 3, or other values.

In some examples, when using wavefront parallel processing (WPP) for parallel coding, video encoder 200 and video decoder 300 may use only available coded CTUs as reference for the current coding CTU. When WPP is enabled, the above examples can still apply. The patterns of reference CTUs may be changed according to the availability of the CTUs.

In some examples, video encoder 200 and video decoder 300 may determine the coded CTUs used as reference as being in the same processing area as the current coding CTU. For example, the reference CTUs (or reference units) may be those that are in the same slice or tile as the current CTU.

In some examples, the number N of coded areas that can be used as reference for the current coding area in IBC mode can be predefined in both video encoder 200 and video decoder 300, or set as a value signaled from video encoder 200 to video decoder 300, e.g., at sequence level (sequence parameter set (SPS)), picture level (picture parameter set (PPS)), slice level, or block level. For example, this value can be signaled in Sequence Parameter Set (SPS), Picture Parameter Set (PPS), Slice header (SH), Coding Tree Unit (CTU) or Coding Unit (CU).

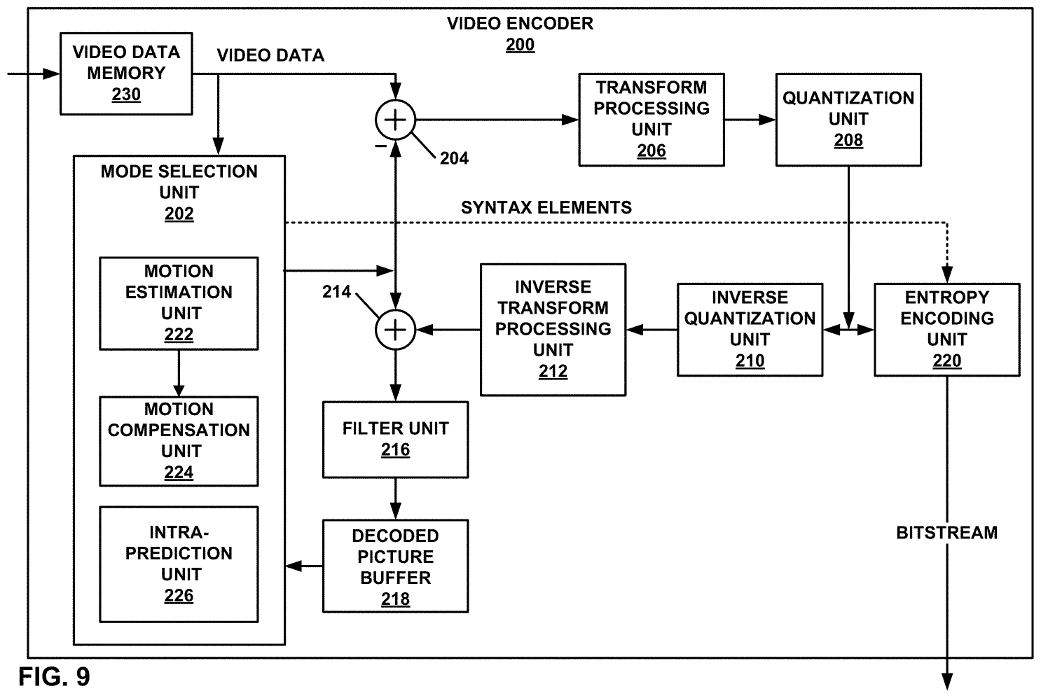

FIG. 9 is a block diagram illustrating an example video encoder 200 that may perform the techniques of this disclosure. FIG. 9 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards, and are applicable generally to video encoding and decoding.

In the example of FIG. 9, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 4). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 4 may also provide temporary storage of outputs from the various units of video encoder 200.

The various units of FIG. 9 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 4) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

IBC mode may be considered an inter-prediction mode, in the sense that IBC mode includes the use of a motion vector to identify a reference block. When performing IBC mode, therefore, motion estimation unit 222 may calculate a motion vector to identify a reference block for a current block, except that the reference block will be in the current picture including the current block. Although referred to as a motion vector in this discussion, the vector may also be referred to as a block vector. According to the techniques of this disclosure, DPB 218 may store up to N reference units (e.g., CTUs, blocks/CUs, groups of pixels/samples, or the like) for reference when video encoder 200 performs IBC mode prediction. Video encoder 200 may discard other blocks coded earlier than the N blocks of the current picture from DPB 218, e.g., after encoding the current CTU. As with inter-prediction mode, motion estimation unit 222 may provide the calculated motion vector to motion compensation unit 224, which may generate a prediction block for the current block using the motion vector, as discussed above, but according to IBC mode, i.e., from the up to N reference units of the current picture stored in DPB 218.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

Video encoder 200 represents an example of a device configured to encode video data including a memory configured to store video data, and one or more processing units implemented in circuitry and configured to determine that a current block of a current picture of video data is to be predicted using intra-block copy (IBC) mode, determine up to N reference units (e.g., blocks, CTUs, groups of pixels, or the like) that are available for use as reference to predict the current block using IBC mode, N being an integer value less than a total number of previously coded units (e.g., blocks, CTUs, or groups of pixels) of the current picture, generate a prediction block for the current block using one or more of the N reference units using IBC mode, and code the current block using the prediction block.

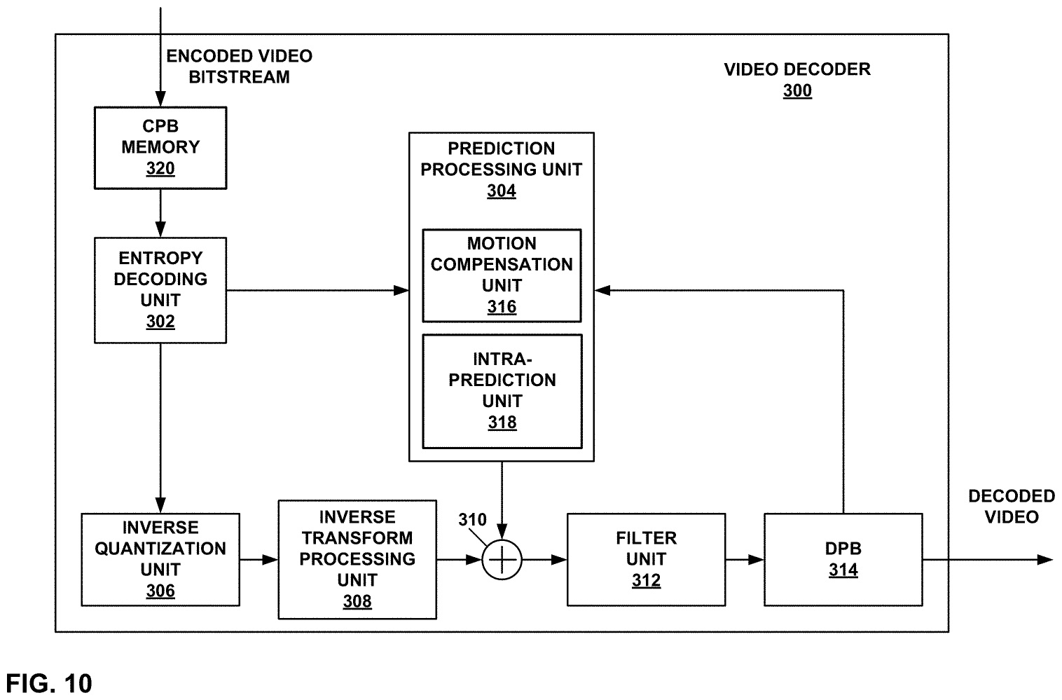

FIG. 10 is a block diagram illustrating an example video decoder 300 that may perform the techniques of this disclosure. FIG. 10 is provided for purposes of explanation and is not limiting on the techniques as broadly exemplified and described in this disclosure. For purposes of explanation, this disclosure describes video decoder 300 is described according to the techniques of JEM, VVC, and HEVC. However, the techniques of this disclosure may be performed by video coding devices that are configured to other video coding standards.

In the example of FIG. 10, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 4). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAIVI), resistive RAM (RRAIVI), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 4). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units shown in FIG. 10 are illustrated to assist with understanding the operations performed by video decoder 300. The units may be implemented as fixed-function circuits, programmable circuits, or a combination thereof. Similar to FIG. 9, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 9).

In response to receiving data indicating that a current block is to be predicted using IBC mode, motion compensation unit 316 may receive a decoded motion vector that identifies a reference block for a current block, except that the reference block will be in the current picture including the current block. Although referred to as a motion vector in this discussion, the vector may also be referred to as a block vector. According to the techniques of this disclosure, DPB 314 may store up to N reference units (e.g., CTUs, blocks/CUs, groups of pixels/samples, or the like) for reference when video decoder 300 performs IBC mode prediction. Video decoder 300 may discard other blocks coded earlier than the N blocks of the current picture from DPB 314, e.g., after decoding the current CTU.

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 9). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 4.

In this manner, video decoder 300 represents an example of a video decoding device including a memory configured to store video data, and one or more processing units implemented in circuitry and configured to determine that a current block of a current picture of video data is to be predicted using intra-block copy (IBC) mode, determine up to N reference units (e.g., blocks, CTUs, groups of pixels, or the like) that are available for use as reference to predict the current block using IBC mode, N being an integer value less than a total number of previously coded units (e.g., blocks, CTUs, or groups of pixels) of the current picture, generate a prediction block for the current block using one or more of the N reference units using IBC mode, and code the current block using the prediction block.

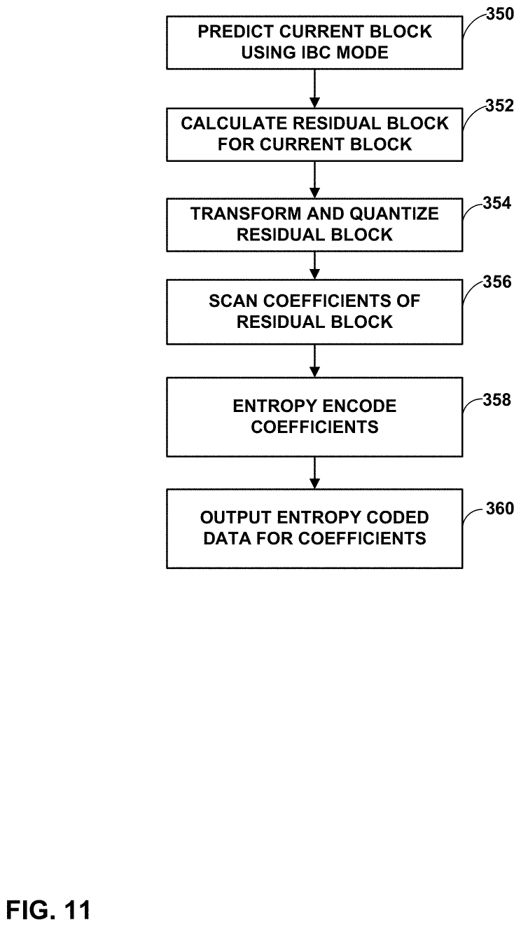

FIG. 11 is a flowchart illustrating an example method for encoding a current block in accordance with the techniques of this disclosure. The current block may comprise a current CU. Although described with respect to video encoder 200 (FIGS. 4 and 9), it should be understood that other devices may be configured to perform a method similar to that of FIG. 11.

In this example, video encoder 200 initially predicts the current block (350). In particular, in this example, video encoder 200 may use intra-block copy (IBC) mode to predict the current block from up to N reference units determined according to any of the various techniques of this disclosure, thereby forming a prediction block for the current block. For example, the N reference units may be CTUs, CUs/blocks, or other groups of pixels/samples. The N reference units may be the N most recently coded reference units, up to N most recently coded reference units in a row including the current block, or up to N previously coded reference units that are closest in distance to the current block.

Video encoder 200 may then calculate a residual block for the current block (352). To calculate the residual block, video encoder 200 may calculate a difference between the original, uncoded block and the prediction block for the current block. Video encoder 200 may then transform and quantize coefficients of the residual block (354). Next, video encoder 200 may scan the quantized transform coefficients of the residual block (356). During the scan, or following the scan, video encoder 200 may entropy encode the coefficients (358). For example, video encoder 200 may encode the coefficients using CAVLC or CABAC. Video encoder 200 may then output the entropy coded data of the block (360).

In this manner, the method of FIG. 11 represents an example of a method of coding video data including determining that a current block of a current picture of video data is to be predicted using intra-block copy (IBC) mode; determining up to N reference units that are available for use as reference to predict the current block using IBC mode, N being an integer value less than a total number of previously coded reference units of the current picture; generating a prediction block for the current block using one or more of the N reference units according to IBC mode; and coding the current block using the prediction block.

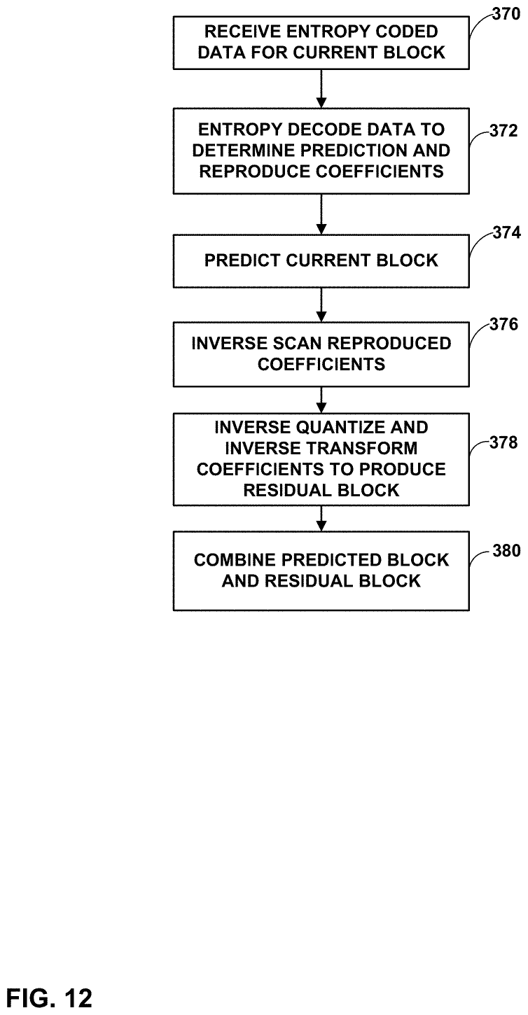

FIG. 12 is a flowchart illustrating an example method for decoding a current block in accordance with the techniques of this disclosure. The current block may comprise a current CU. Although described with respect to video decoder 300 (FIGS. 4 and 10), it should be understood that other devices may be configured to perform a method similar to that of FIG. 12.

Video decoder 300 may receive entropy coded data for the current block, such as entropy coded prediction information and entropy coded data for coefficients of a residual block corresponding to the current block (370). Video decoder 300 may entropy decode the entropy coded data to determine prediction information for the current block and to reproduce coefficients of the residual block (372). Video decoder 300 may predict the current block (374), e.g., using IBC mode as indicated by the prediction information for the current block, to calculate a prediction block for the current block.

In particular, in this example, video decoder 300 may use IBC mode to predict the current block from up to N previously coded reference units, determined according to any of the various techniques of this disclosure, thereby forming a prediction block for the current block. For example, the up to N previously coded reference units may be the up to N most recently coded reference units, the up to N most recently coded reference units that are also in the same row as the current block, or the up to N most recently coded reference units that are closest in distance to the current block. The up to N reference units may be CTUs, blocks, CUs, groups of pixels/samples, or the like.

Video decoder 300 may then inverse scan the reproduced coefficients (376), to create a block of quantized transform coefficients. Video decoder 300 may then inverse quantize and inverse transform the coefficients to produce a residual block (378). Video decoder 300 may ultimately decode the current block by combining the prediction block and the residual block (380).

In this manner, the method of FIG. 12 represents an example of a method of coding video data including determining that a current block of a current picture of video data is to be predicted using intra-block copy (IBC) mode; determining up to N reference units that are available for use as reference to predict the current block using IBC mode, N being an integer value less than a total number of previously coded reference units of the current picture; generating a prediction block for the current block using one or more of the N reference units according to IBC mode; and coding the current block using the prediction block.

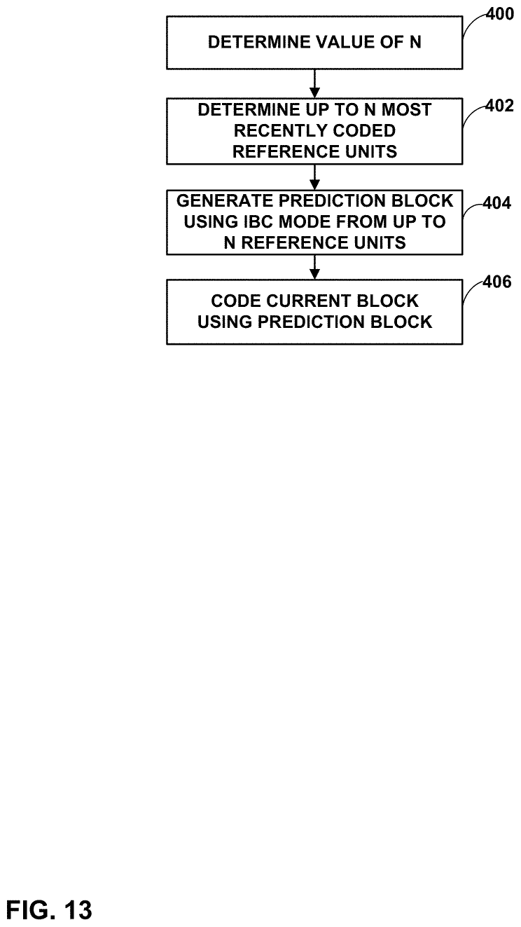

FIG. 13 is a flowchart illustrating an example method of coding video data according to the techniques of this disclosure. The method of FIG. 13 is explained with respect to video decoder 300 of FIGS. 4 and 10 for purposes of example and explanation, although other devices may perform this or a similar method, such as video encoder 200.

Initially, video decoder 300 may determine a value for N (400). In this example, N represents an integer number of previously coded reference units of a current picture that may be used in IBC mode to generate a prediction block. Video decoder 300 may determine the value for N according to, for example, a size of VPDUs for the video data, a size of CTUs for the video data, from configuration data (e.g., if N is a fixed value), or from data signaled in the bitstream. For example, the value of N may be signaled in a VPS, SPS, PPS, picture header, slice header, CTU header, or CU header, in various examples.

Video decoder 300 may then determine up to N previously coded reference units that are available to be used to generate the prediction block for a current block (402). The reference units may be, for example, CTUs, CUs, blocks, groups of pixels/samples, or the like. Video decoder 300 may determine the up to N previously coded reference units as the most recently coded units, the most recently coded units that are also in the same row as the current block, units within a closest distance to the current block, units within the same slice as the current block, and/or units within the same tile as the current block.

Video decoder 300 may then generate the prediction block using IBC mode from the up to N previously coded reference units (404). Video decoder 300 may also code (namely, decode) the current block using the prediction block (406). For example, video decoder 300 may decode a residual block for the current block, and combine samples of the residual block with corresponding samples of the prediction block to reproduce, and thereby decode, the current block.

In this manner, the method of FIG. 13 represents an example of a method of coding video data including determining that a current block of a current picture of video data is to be predicted using intra-block copy (IBC) mode; determining up to N reference units that are available for use as reference to predict the current block using IBC mode, N being an integer value less than a total number of previously coded reference units of the current picture; generating a prediction block for the current block using one or more of the N reference units according to IBC mode; and coding the current block using the prediction block.

Certain techniques of this disclosure can be summarized by the following examples:

### Example 1

A method of coding video data, the method including: determining that a current block of video data is to be predicted using intra-block copy (IBC) mode; determining up to N reference blocks that are available for use as reference to predict the current block using IBC mode, N being an integer value; generating a prediction block for the current block using one or more of the N reference blocks using IBC mode; and coding the current block using the prediction block.

### Example 2

The method of example 1, wherein determining the up to N reference blocks includes determining the N reference blocks as corresponding to up to N most recently coded blocks preceding the current block.

### Example 3

The method of example 1, wherein determining the up to N reference blocks includes determining the N reference blocks as corresponding to up to N most recently coded blocks preceding the current block that are also within a row including the current block and excluding blocks outside of the row including the current block.

### Example 4

The method of example 1, wherein determining the up to N reference blocks includes determining the up to N reference blocks having a closest distance to the current block.

### Example 5

The method of example 4, wherein the closest distance includes a distance less than or equal to a threshold distance from a position of the current block.

### Example 6

The method of any of examples 1-5, further including determining a value for N according to a size of a virtual pipeline data unit (VPDU) for the video data.

### Example 7

The method of example 6, wherein determining the value for N includes, when the size of the VPDU is 32×32, determining the value for N as being equal to 15.

### Example 8

The method of any of examples 1-5, further including determining a value for N according to a size of a coding tree unit (CTU) for the video data.

### Example 9

The method of any of examples 1-5, further including determining a value for N as a fixed value.

### Example 10

The method of example 9, wherein the value for N includes one of 1, 2, or 3.

### Example 11

The method of any of examples 1-5, further including coding a value for N as a syntax element.

### Example 12

The method of example 11, wherein the syntax element forms part of at least one of a sequence parameter set (SPS), a picture parameter set (PPS), a video parameter set (VPS), a slice header, a coding tree unit header, or a coding unit header.

### Example 13

The method of any of examples 1-12, wherein determining the up to N reference blocks includes determining the up to N reference blocks within a slice including the current block and excluding blocks outside of the slice.

### Example 14

The method of any of examples 1-12, wherein determining the up to N reference blocks includes determining the up to N reference blocks within a tile including the current block and excluding blocks outside of the tile.

### Example 15

The method of any of examples 1-14, wherein determining the up to N reference blocks includes determining the up to N reference blocks as being available blocks and excluding blocks that are not available.

### Example 16

The method of any of examples 1-15, wherein the current block includes one of a coding tree unit (CTU), a coding unit (CU), a video block, or a group of pixel samples.

### Example 17

The method of any of examples 1-16, wherein each of the up to N reference blocks includes one of a coding tree unit (CTU), a coding unit (CU), a video block, or a group of pixel samples.

### Example 18

The method of any of examples 1-17, wherein generating the prediction block includes: determining a motion vector for the current block that refers to a reference block within the up to N reference blocks, the current block being within a current picture and the up to N reference blocks being within the current picture; and generating the prediction block using the motion vector.

### Example 19

The method of example 18, further including coding the motion vector.

### Example 20

The method of any of examples 1-19, wherein coding the current block includes: decoding a residual block for the current block; and adding samples of the prediction block to samples of the residual block to decode the current block.

### Example 21

The method of any of examples 1-20, wherein coding the current block includes: subtracting samples of the prediction block from samples of the current block to form a residual block; and encoding the residual block to encode the current block.

### Example 22

A device for decoding video data, the device including one or more means for performing the method of any of examples 1-21.

### Example 23

The device of example 22, further including a display configured to display decoded video data.

### Example 24

The device of example 22, wherein the device includes one or more of a camera, a computer, a mobile device, a broadcast receiver device, or a set-top box.

### Example 25

The device of example 22, further including a memory configured to store the video data.

### Example 26

A device for encoding video data, the device including: means for determining that a current block of video data is to be predicted using intra-block copy (IBC) mode; means for determining up to N reference blocks that are available for use as reference to predict the current block using IBC mode, N being an integer value; means for generating a prediction block for the current block using one or more of the N reference blocks using IBC mode; and means for coding the current block using the prediction block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining that a current block of a current picture of video data is to be predicted using intra-block copy (IBC) mode;
determining up to N reference units that are available for use as reference to predict the current block using IBC mode, N being an integer value less than a total number of previously coded reference units of the current picture;
generating a prediction block for the current block using one or more of the N reference units according to IBC mode; and
coding the current block using the prediction block.

2. The method of claim 1, wherein determining the up to N reference units comprises determining the N reference units as corresponding to up to N most recently coded reference units preceding the current block in coding order.

3. The method of claim 1, wherein determining the up to N reference units comprises determining the N reference units as corresponding to up to N most recently coded reference units preceding the current block in coding order that are also within a row of the current picture including the current block and excluding reference units outside of the row including the current block.

4. The method of claim 3, wherein the reference units comprise respective coding tree units (CTUs) and the current block comprises a coding unit (CU).

5. The method of claim 1, wherein determining the up to N reference units comprises determining the up to N reference units having a closest distance to the current block.

6. The method of claim 5, wherein the closest distance comprises a distance less than or equal to a threshold distance from a position of the current block.

7. The method of claim 1, further comprising determining a value for N according to a size of a virtual pipeline data unit (VPDU) for the video data.

8. The method of claim 7, wherein determining the value for N comprises, when the size of the VPDU is 32×32, determining the value for N as being equal to 15.

9. The method of claim 1, further comprising determining a value for N according to a size of a coding tree unit (CTU) for the video data.

10. The method of claim 1, further comprising determining a value for N as a fixed value.

11. The method of claim 10, wherein the value for N comprises one of 1, 2, or 3.

12. The method of claim 1, further comprising coding a value for N as a syntax element.

13. The method of claim 12, wherein the syntax element forms part of at least one of a sequence parameter set (SPS), a picture parameter set (PPS), a video parameter set (VPS), a slice header, a coding tree unit header, or a coding unit header.

14. The method of claim 1, wherein determining the up to N reference units comprises determining the up to N reference units within a slice including the current block, the N reference units excluding reference units outside of the slice.

15. The method of claim 1, wherein determining the up to N reference units comprises determining the up to N reference units within a tile including the current block, the N reference units excluding reference units outside of the tile.

16. The method of claim 1, wherein determining the up to N reference units comprises determining the up to N reference units as being available reference units, the N reference units excluding blocks that are not available.

17. The method of claim 1, wherein the current block comprises one of a coding tree unit (CTU), a coding unit (CU), a video block, or a group of pixel samples.

18. The method of claim 1, wherein each of the up to N reference units comprises a respective one of a coding tree unit (CTU), a coding unit (CU), a video block, or a group of pixel samples.

19. The method of claim 1, wherein generating the prediction block comprises:
determining a motion vector for the current block that refers to a reference block within the up to N reference units, the current block being within a current picture and the up to N reference units being within the current picture; and
generating the prediction block using the motion vector.

20. The method of claim 19, further comprising coding the motion vector.

21. The method of claim 1, wherein coding the current block comprises:
decoding a residual block for the current block; and
adding samples of the prediction block to samples of the residual block to decode the current block.

22. The method of claim 1, wherein coding the current block comprises:
subtracting samples of the prediction block from samples of the current block to form a residual block; and
encoding the residual block to encode the current block.

23. A device for coding video data, the device comprising:
a memory configured to store video data; and
one or more processors implemented in circuitry and configured to:
determine that a current block of a current picture of video data is to be predicted using intra-block copy (IBC) mode;
determine up to N reference units that are available for use as reference to predict the current block using IBC mode, N being an integer value less than a total number of previously coded reference units of the current picture;
generate a prediction block for the current block using one or more of the N reference units according to IBC mode; and
code the current block using the prediction block.

24. The device of claim 23, wherein the one or more processors are configured to determine the up to N reference units as corresponding to up to N most recently coded reference units preceding the current block in coding order that are also within a row of the current picture including the current block and excluding reference units outside of the row including the current block.

25. The device of claim 24, wherein the reference units comprise respective coding tree units (CTUs) and the current block comprises a coding unit (CU).

26. The device of claim 23, further comprising a display configured to display decoded video data.

27. The device of claim 23, wherein the device comprises one or more of a camera, a computer, a mobile device, a broadcast receiver device, or a set-top box.

28. A device for coding video data, the device comprising:
means for determining that a current block of video data is to be predicted using intra-block copy (IBC) mode;
means for determining up to N reference units that are available for use as reference to predict the current block using IBC mode, N being an integer value less than a total number of previously coded reference units of the current picture;
means for generating a prediction block for the current block using one or more of the N reference units according to IBC mode; and
means for coding the current block using the prediction block.

29. A computer-readable storage medium having stored thereon instructions that, when executed, cause a processor to:
determine that a current block of a current picture of video data is to be predicted using intra-block copy (IBC) mode;
determine up to N reference units that are available for use as reference to predict the current block using IBC mode, N being an integer value less than a total number of previously coded reference units of the current picture;
generate a prediction block for the current block using one or more of the N reference units according to IBC mode; and
code the current block using the prediction block.

30. The computer-readable storage medium of claim 29, wherein the reference units comprise respective coding tree units (CTUs), wherein the current block comprises a current coding unit (CU), and wherein the instructions that cause the processor to determine the up to N CTUs comprise instructions that cause the processor to determine the N CTUs as corresponding to up to N most recently coded CTUs preceding the current CU in coding order that are also within a CTU row of the current picture including the current CU and excluding CTUs outside of the CTU row including the current block.
